(19) United States
(12) Patent Application Publication
(10) Pub. No.: US 2011/0183529 A1
(43) Pub. Date: Jul. 28, 2011

(54) TOLERANCE COMPENSATING, ELECTRIC CONNECTOR, IN PARTICULAR FOR MOTOR VEHICLE CONTROL DEVICES

(75) Inventors: Andreas Heise, Erzhausen (DE); Wolfgang Käfer, Frankfurt (DE); Jürgen Scherschmidt, Frankfurt (DE); Jörn Schriefer, Griesheim (DE)

(73) Assignee: Continental Teves AG & Co. oHG, Frankfurt (DE)

(21) Appl. No.: 12/992,171

(22) PCT Filed: May 13, 2009
(86) PCT No.: PCT/EP09/55747

§ 371 Date: Jan. 25, 2011

(30) Foreign Application Priority Data
May 13, 2008 (DE) 10 2008 023 280.7
May 12, 2009 (DE) 10 2009 020 984.0

(51) Int. Cl. H01R 41/00

(52) U.S. Cl. 439/1

(57) ABSTRACT

An electric connector with a tolerance compensator, includes a plug-in part and a counter part. An electric connection is established when the plug-in part including at least one electrically conductive pin is plugged into the counter part in the z-direction of a Cartesian coordinate system. The counter part has volume elastic properties, is electrically conductive and forms a predetermined volume. The counter part is limited in the z-direction by, respectively, one contact surface. In order to establish an electric connection, the at least one electrically conductive pin is aligned essentially in the counterpart in the z-direction and traverses a contact surface in an essentially perpendicular manner. The volume area of the counter part is calculated such that the pin reaches the volume allowing a reliable electric connected to be established, in the framework of a permitted path tolerance in the x- and/or y-direction when plugging together.

### CROSS REFERENCE TO RELATED APPLICATIONS

This application is the U.S. national phase application of PCT International Application No. PCT/EP2009/055747, filed May 13, 2009, which claims priority to German Patent Application No. 10 2008 023 280.7, filed May 13, 2008, and German Patent Application No. 10 2009 020 984.0, filed May 12, 2009, the content of such applications being incorporated by reference herein.

### FIELD OF THE INVENTION

The invention relates to an electric connector with a tolerance compensator.

### BACKGROUND OF THE INVENTION

In electrical engineering/electronics, in particular motor vehicle electronics, and wherever electronic assemblies are mounted on mechanical or hydraulic assemblies in order to connect electric motors, coils, sensors or actuators electrically, there is frequently the problem that tolerances between individual electric contact points or plugs have to be bypassed. If a plurality of electric contact points are arranged distributed in a planar fashion over an assembly and/or if other components are relevant for the positioning of the assemblies, the electric connectors have to be able to absorb these tolerances.

When customary plug-type connectors are used there is also the risk of mechanical stresses being passed onto the contact points since they are mounted fixedly and have a preferred insertion duct.

In particular in the case of soldered contacts, this could lead to fatigue fractures in the solder, which must be prevented under all circumstances.

Known plug-type connectors with a tolerance compensator which are used in ABS brake control units for motor vehicles are composed, for example, of spring elements or of plugs/sockets which are suspended in such a way that they can be slid in a sprung fashion by means of stranded conductors or pieces of sheet metal.

Such solutions are technically complex and therefore give rise to high manufacturing costs.

DE 10 2005 041 892 A1, which is incorporated by reference, discloses an electric plug-type connector of the generic type with a pin carrier which has projecting electrically conductive pins which enter into electrical contact with receptacles, assigned to the pins, of a receptacle carrier, the receptacles being formed by hoses or sleeves which are guided in a cable and which usually enclose stranded conductors extending along the cable. The pins are therefore not plugged into empty sleeve-shaped receptacles but rather into receptacles which are already filled with the electrical lines of the cable, wherein, for example, a stranded conductor which is formed by a bundle of very fine wires is used and pointed pins in the form of a lance facilitate the penetration of the stranded conductor of the cable by the latter. The advantage of this known electric connector is that installation space can be saved by dispensing with a plug which is attached to a cable and in which, for example, the stranded conductors of the cable are connected individually to the receptacles.

This known electric connector likewise does not solve the abovementioned problem of electrically connecting electric assemblies in a tolerance-compensating fashion to sensor assemblies or actuator assemblies, such that overall a compact assembly is obtained, and in particular a cable connection according to DE 10 2005 041 892 A1 is not suitable.

### SUMMARY OF THE INVENTION

An object of the invention is to specify an electric connector with which assemblies can be electrically connected in a tolerance-compensating fashion and implemented cost-effectively.

This object is achieved by means of an electric connector.

Accordingly, in an electric connector with a tolerance compensator, composed of a plug-in part and a counter part, in which an electrical connection is produced when the plug-in part, comprising at least one electrically conductive pin, and the counter part are plugged together in the z direction, according to aspects of the invention the counter part has an elastic volume and forms a predefined volume area, wherein the counter part is limited in the z direction by, in each case, one end-side contact face; in addition, in order to form the electrical connection, the at least one electrically conductive pin, which is embodied, in particular, as a contact lance, is oriented essentially in the counter part in the z direction and essentially perpendicularly penetrates a contact face, wherein the volume area which is formed by the counter part is dimensioned in such a way that the pin engages with the volume area within the scope of a permitted travel tolerance in the x and/or y directions during the plugging together process, in order to form a reliable electrical connection.

With this counter part or connecting element according to aspects of the invention, it is possible to span any desired tolerance by means of the dimensioning of said counter part or connecting element in the x and y directions, i.e. by correspondingly selecting the end-side contact faces.

In one preferred development of the invention, the volume area which is formed by the counter part has such a large extent in the z direction that a permitted travel tolerance is also provided in the z direction. It is therefore also possible to span any tolerance in the z direction by correspondingly selecting the coverage length between the pin and the counter part or the connecting element.

The volume elasticity of the counter part or of the connecting element ensures that the pin which is preferably embodied as a contact lance can be plugged elastically into the counter part and it therefore ensures a permanent electrical connection.

The counter part ideally forms a volume area with a large number of electrically conductive elements which are preferably embodied as thin, electrically conductive elements, in particular as wires, which extend essentially in the z direction.

It is also advantageous to use metal felt, metal wool, metal mesh or metalized plastic fabric instead of thin wires for the electrically conductive elements of the counter part.

With such electrically conductive elements it is possible for a pin or a plurality of pins to be easily pushed into a counter part or connecting element which is constructed therewith, with the result that in the process the wires or the other conductive elements which are used move out and yet at the same time enter into contact with one another over a large surface and therefore ensure a permanent electrical connection.

In a further advantageous development of the invention, the counter part or the connecting element is not only embodied with an elastic volume but is additionally dimensionally elastic. It is therefore additionally possible for assemblies or printed circuit boards which are pushed one against the other during operation to be permanently and reliably electrically connected by means of such a counter part or connecting element. This also makes it possible, for example, to use such a bent counter part or connecting element to connect electrically to one another, for example, two contact points in a housing which can only be accessed with difficulty and which cannot be connected linearly.

It is particularly advantageous to hold the conductive elements together with a holding means, wherein the electrically conductive elements of the counter part are preferably combined, using the holding means as at least one bundle, preferably into a bundle of electrically conductive wires, in particular into at least one stranded conductor or one bundled piece of metal felt, metalized plastic fabric, metal mesh or a bundled piece of metal wool.

The wires or the other specified electrically conductive elements are preferably composed of copper as a base material or of a copper alloy, which can also be gold-plated or silver-plated, and which are in parallel in the z direction or stranded one next to the other. Other metals such as aluminum or stainless steel, even metallically coated non-conductors, for example plastic threads, can also be used and can likewise be gold-plated or silver-plated.

According to one development of the invention, the holding means is embodied as a jacket, for example as a sleeve, preferably as a dimensionally elastic jacket, for example as a plastic jacket or as a silicone hose, in addition as a ring, as a braided element, as a twisted element or as an adhesive material. With this development of the invention, the counter part or the connecting element constitutes an electric component which can be used in a versatile way.

It is particularly advantageous to construct the holding means in such a way that the volume area which is formed by the counter part is surrounded with the conductive elements at least in a partially annular or cylindrical shape, wherein the holding means preferably has an interruption which acts elastically when the pin is inserted into the volume area. Clamping rings or clamping sleeves are preferably suitable for this.

In one particularly advantageous development, the holding part is embodied as a jacket in such a way that, in order to accommodate one, two, three or four bundles of conductive elements, it is constructed with one conductor, two, three or four conductors or has more than four conductors in order to accommodate more than four bundles of conductive elements. In this way, a plurality of contact-forming means which are provided for different functions (ground terminal, voltage supply, signal terminals etc.) can be simultaneously implemented with a single counter part or connecting element as the component.

The component, which is embodied separately and is composed of a counter part or connecting element with a jacket, can also be advantageously integrated into a housing in that the jacket is held by the housing which surrounds the jacket in an annular shape, and preferably has an annular elevated portion which compresses the jacket in the manner of a bead.

In this context, the holding means can be manufactured particularly advantageously and cost-effectively if it is embodied as an integrated part of a housing, in particular of a housing wall of a plastic housing.

If the counter part or connecting element according to aspects of the invention is integrated in this way into a housing, a space-saving electrical connection is produced from an assembly arranged in the housing, preferably a printed circuit board, to the exterior of the housing.

It is particularly advantageous to embody at least one contact face of the counter part or of the connecting element in such a way that it can be soldered, so that such a component composed of a counter part and a holding means or jacket can easily be soldered, for example, into a printed circuit board.

Such a component can preferably be improved to the effect that the holding means encloses the electrically conductive elements in a jacket shape and surrounds the edge area of a contact face in the manner of a frame. This contact face which is surrounded in the manner of a frame can therefore be embodied as a soldered connection in order therefore to be able to solder this component into or onto a printed circuit board.

In addition, such a component can also be embodied in such a way that a contact face of the counter part is covered completely with an electrically conductive lid, wherein a metallic jacket as holding means and said electrically conductive lid are preferably embodied in one piece.

In a further advantageous development of the invention it is possible to protect the counter part or the connecting element according to aspects of the invention against the ingress of moisture, liquids, in particular water and gases, by wetting the conductive elements with an adhesively acting bonding agent.

In addition it is also possible to crosslink the conductive elements with an elastic plastic, preferably with an elastomer.

In another development of the invention, electrically conductive metal particles or metalized particles, preferably silver-plated or gold-plated, which are embedded in a plastic with an elastic volume, preferably an elastomer, can also preferably be used as conductive elements.

A particularly preferred development of the invention is obtained in that the counter part or the connecting element for embodying the volume area is formed from electrically conductive plastic, preferably from a conductive polymer, in particular such a counter part is composed of conductive rubber. Such a counter part or connecting element can preferably be of cylindrical design, wherein the longitudinal axis thereof is oriented approximately in the z direction.

A counter part or connecting element can ideally be embodied in such a way that its circumferential face forms, in addition to the end-side contact faces (11a, 11b), a further contact face in the z direction, which provides expanded application possibilities. This further contact face is preferably formed by an electrically conductive jacket.

It is particularly advantageous to embody the counter part or the connecting element as an SMD component in that an SMD adapter which is embodied in a spider shape is provided, which SMD adapter encloses an end-side contact face and the adjoining circumferential face of the counter part. This permits, for example, a printed circuit board to be equipped by machine.

The electric connector according to aspects of the invention, which is composed of a counter part or a connecting element and a pin, can advantageously be used in such a way that the pin and/or the counter part are/is electrically connected to a printed circuit board.

It is also possible that the two end-side contact faces of the counter part or of the connecting element are each connected to a printed circuit board or to an electric component via a pin.

Furthermore, in one advantageous development of the invention a first and a second counter part are connected to one another via a double pin, wherein the double pin is arranged in a printed circuit board.

In particular, the end of the pin which lies opposite the counter part can constitute a plug pin, in particular of a plug. It is therefore possible for a housing plug to be connected in a flexible way to a printed circuit board which is arranged in the housing.

A particularly advantageous use of the connector according to aspects of the invention is for the counter part or the connecting element or the pin to be used to cool electronic components by virtue of the fact that heat is conducted away via these components.

This is either preferably done in that the pin is arranged directly so as to conduct away heat at a location which is to be cooled on a printed circuit board, and the pin serves additionally also to conduct away heat to the electrical connection to the counter part, or in that the counter part is arranged directly so as to conduct away heat at a location which is to be cooled on a printed circuit board, and at least one pin forms an electrical connection.

One further advantageous use of the connector according to aspects of the invention arises with the connection of a sensor, in particular of a pressure sensor, to an electronic unit, wherein contact is preferably made with the sensor when a hydraulic unit ECU is connected to an electronic control device HCU, so that, owing to its design, the connector according to aspects of the invention compensates fabrication tolerances with respect to the position of the electrical connection/connections formed during the joining together process.

In a further advantageous use of the connector according to aspects of the invention, a plurality of electric components, preferably valve coils, for example of an ABS control unit, are connected together to a common potential and to drive electronics.

A particularly advantageous use of the connector according to aspects of the invention with a counter part or connecting element which has, in addition to the end-side contact faces, a further contact face, constitutes an electrical connection of a printed circuit board via the further contact face of the counter part to a pin which forms a plug pin, in particular of a plug. It is therefore advantageously possible to form a connection which runs geometrically at a right angle.

In particular, in this context, in order to place the further contact face of the counter part in contact with a printed circuit board, the counter part can be introduced into a via in the printed circuit board, wherein the via is preferably arranged in a semicircular shape on an end side of the printed circuit board, and the counter part is clamped in between a housing wall and the semicircular via.

Finally, in a further advantageous use of the connecting element according to aspects of the invention, said connecting element is guided in an arcuate shape, within an electric assembly, for example an ABS control unit, from one contact terminal to a further contact terminal, wherein at least one contact terminal makes contact, by means of a pin, with the counter part via its further contact face.

### BRIEF DESCRIPTION OF THE DRAWINGS

The invention is best understood from the following detailed description when read in connection with the accompanying drawings. Included in the drawings is the following Figures:

FIG. 1 shows an exemplary embodiment of an electric connector according to aspects of the invention for connecting to two printed circuit boards,

FIGS. 2a and 2b show further exemplary embodiments of an electric connector according to aspects of the invention for connecting to two or three printed circuit boards,

FIGS. 3a-3d show exemplary embodiments of the embodiment of a counter part or a connecting element according to aspects of the invention,

FIGS. 4a-4e show further exemplary embodiments for connecting a counter part or connecting element as an SMD component according to aspects of the invention to a printed circuit board,

FIGS. 5a and 5b show configuration possibilities and arrangement possibilities of pins on a printed circuit board according to aspects of the invention,

FIGS. 6a-6d show cross-sectional illustrations of counter parts and/or connecting elements as exemplary embodiments according to aspects of the invention,

FIGS. 7a-7d show exemplary embodiments of counter parts or connecting elements with different holding means according to aspects of the invention,

FIGS. 8a-8d show exemplary embodiments of counter parts or connecting elements with crimped, electrically conductive elements according to aspects of the invention,

FIG. 9 shows an exemplary embodiment for the use of the electric connector according to aspects of the invention for cooling,

FIG. 10 shows a further exemplary embodiment for the use of the electric connector according to aspects of the invention for connecting a printed circuit board to a housing plug,

FIG. 11 shows an exemplary embodiment for connecting two counter parts or connecting elements to a double lance as a pin,

FIG. 12 shows a further exemplary embodiment of an electric connector according to aspects of the invention for use as a cooling means,

FIGS. 13a and 13b show an exemplary embodiment of a pin as a plug-in lance according to aspects of the invention,

FIG. 14 shows an exemplary embodiment of a counter part for connecting a printed circuit board to an electric component according to aspects of the invention,

FIG. 15 shows an exemplary embodiment of an electrical connection of a printed circuit board to an electric component by means of a counter part or connecting element according to aspects of the invention,

FIGS. 16a and 16b show an exemplary embodiment of an electrical connection of a printed circuit board arranged in a housing to a housing plug by means of a counter part or connecting element according to aspects of the invention,

FIGS. 17a and 17b show an exemplary embodiment of an electrical connection between a printed circuit board which is arranged in a housing and a housing plug by means of a counter part or a connecting element with an additional contact face,

FIG. 18 shows the exemplary embodiment according to FIGS. 17a and 17b with a plug-in pin, arranged perpendicularly to the z direction of the counter part or connecting element, of a housing plug,

FIG. 19 shows the exemplary embodiment according to FIGS. 17a and 17b with a plug-in pin, arranged in the z direction of the counter part or connecting element, of a housing plug,

FIG. 20 shows an exemplary embodiment of an electrical connection between a printed circuit board and a plurality of electric components by means of a counter part or connecting element according to aspects of the invention,

FIG. 21 shows an exemplary embodiment of an electrical connection within an electric assembly by means of a connecting element according to aspects of the invention, and

FIG. 22 shows an exemplary embodiment of an electrical connection between a printed circuit board and an electric component with a connecting element according to aspects of the invention.

### DETAILED DESCRIPTION OF THE PREFERRED EMBODIMENTS

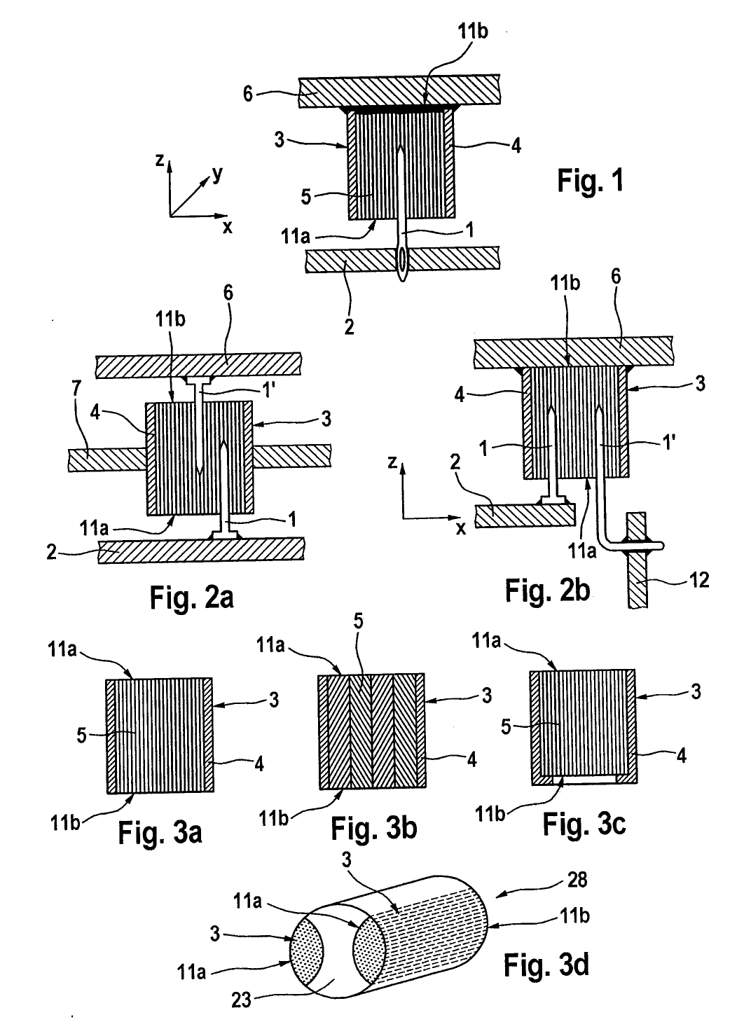

FIGS. 1 to 22 show how the tolerance-compensating electric connector according to aspects of the invention can be constructed, fabricated and, for example, attached to housings and/or printed circuit boards.

The tolerance-compensating connection technique according to aspects of the invention is composed both of a plug-in part and of a counter part, also referred to below as connecting element, which is constructed from a cluster of preferably fine wires, in particular copper wires, as conductive elements which lie essentially in the parallel direction or else stranded one next to the other and form, for example, a stranded conductor. Instead of fine wires as conductive elements it is also possible to use metal felt, metal wool, metal mesh or metalized plastic fabric, preferably a metalized touch and close fastener.

Metal particles which are molded with an elastic plastic, for example an elastomer in order to form a predefined volume area are also suitable as conductive elements.

Finally, it is also possible to manufacture the counter part or the connecting element for forming a predefined volume area with an electrically conductive plastic, for example PBT (polybutylene terephthalate), preferably in order to form conductive rubber.

The following exemplary embodiments describe counter parts or connecting elements according to aspects of the invention which are constructed with bundled wires, referred to as wire bundles or wire groupings. Without being expressly mentioned as such, the alternative embodiments specified above can also be used for such counter parts or connecting elements.

FIG. 1 shows an example of the simplest form of an electric connector according to aspects of the invention, composed of a conductive pin 1 as a plug-in part which is attached to a first printed circuit board 2, and a counter part 3 having at the end side in each case a contact face 11a and 11b and into which pin 1 is introduced in a conductive fashion in the z direction via the contact face 11a when plugging together occurs. The counter part 3 is composed of a tubular jacket 4 as a holding means and a plurality of electrically conductive thin wires 5 as conductive elements which are conductively connected to a conductor track of the second printed circuit board 6 via the other contact face 11b by means of a soldered connection, wherein this contact face 11b is of solderable design. The printed circuit board 6 holds the counter part 3 securely against a surface in this context. The jacket 4 has a cylindrical extent and therefore comprises a volume area which is filled essentially completely and uniformly, preferably homogeneously, with the plurality of wires 5. These wires 5 as conductive individual elements are, in comparison to the volume, small at least in the x and y directions, with the result that a plurality of the electrically conductive individual elements are necessary in order to fill the volume homogenously.

As is apparent from FIG. 1, the position in which pin 1 forms secure contact connection with the counter part 3 can fluctuate in an area which corresponds essentially to the extent of the volume area mentioned above. It is therefore very easily possible to bring about tolerance compensation in all three spatial directions x, y and z.

FIG. 2 shows exemplary embodiments of the connector according to aspects of the invention with two pins 1 and 1′.

FIG. 2a shows an embodiment of the invention of the tolerance-compensating connector integrated into an intermediate floor 7 of a housing, for example plastic housing which makes contact in the same way with an equipped printed circuit board 6 (electric components are not illustrated) and a further printed circuit board 2 which, for example, also makes contact with sensors or actuators. In this context, the pin 1 penetrates a connecting element 3 via its contact face 11a, while the pin 1′ penetrates the connecting element 3 via the contact face 11b lying opposite. The two pins 1 and 1′ are connected via soldered contacts to conductor tracks running on the printed circuit boards 2 and 6.

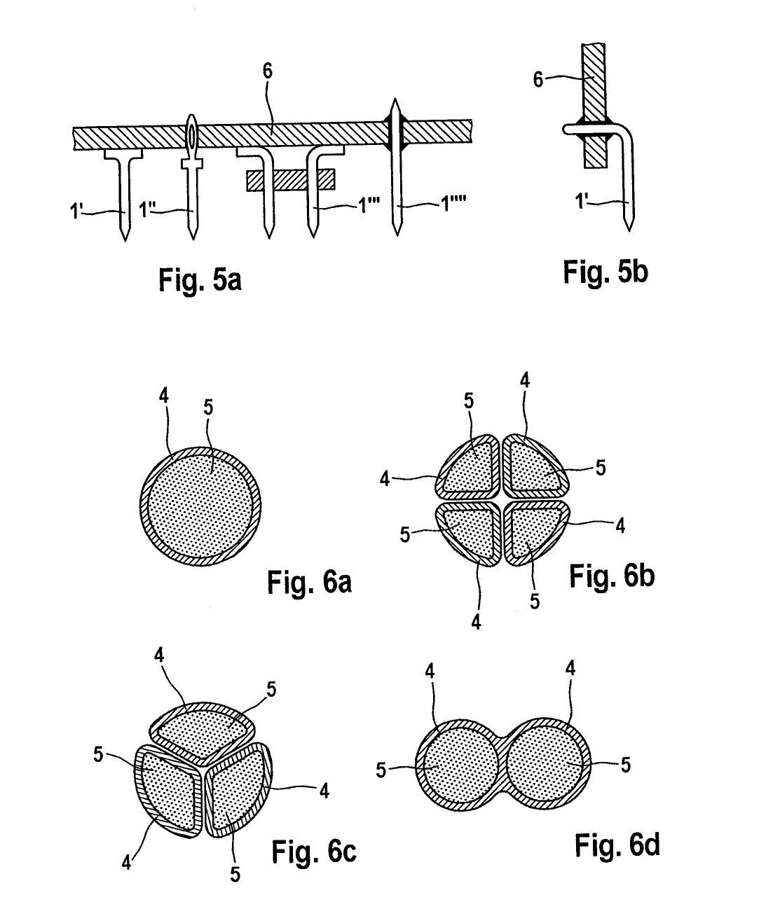

As is shown by FIG. 5a, the plug-in parts which are embodied as pins 1 can easily be mounted on a printed circuit board 6, for example as an SMD pin 1′, as press-in contact pin 1″, as double pin or multiple pin 1″′ or as a soldered-in pin 1″″. As is illustrated in the partial diagram b) in FIG. 5, these pins can also be inserted in a bent form, as is shown by pin 1′.

FIGS. 3a to 3c show longitudinal sections, and FIG. 3d shows a perspective illustration, of connecting elements 3 according to aspects of the invention with different designs. In the partial diagram a), the individual wires 5 are held by a jacket 4. The wires 5 are arranged essentially parallel to one another. In the partial diagram b), the wires 5 are stranded to one another. In the partial diagram c), the jacket 4 is also guided over an edge region of the contacting face lib, which lies in the x/y plane, with the result that the copper wires 5 cannot so easily drop out of the jacket 4. FIG. 3d shows a cylindrical SMD component 28 which is composed of two connecting elements 3, each with end-side contact faces 11a and 11b. The two connecting elements are each embodied in cross section as a circular section with insulating material 23 lying between them, with the result that this SMD component 28 can be used as a two-pole connecting element. The two connecting elements 3 are each composed of molded-in metal particles or electrically conductive plastic. Metal mesh which is impregnated with an elastic plastic or a stranded conductor can also be used for this purpose.

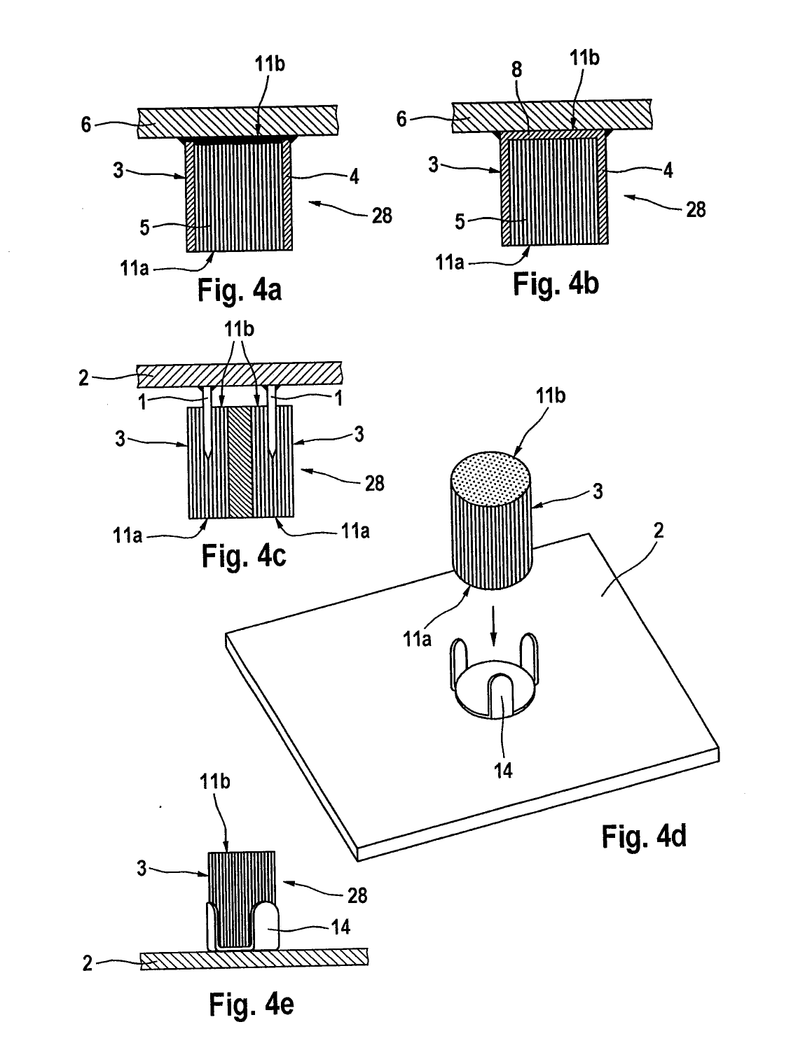

As is shown by the illustrations in FIGS. 4a and 4b, for certain applications the conductive elements 5 which are enclosed by a jacket 4, embodied here as a wire grouping, can also be used as a component with a plastic jacket 4 or a metal jacket 4 (metal ring) for forming an SMD component 28. In the partial diagram a), the wires 5 are soldered directly to the printed circuit board 6 via a contact face of the connecting element 3. In the partial diagram b), attachment is carried out by means of the jacket 4, which preferably has a connecting lid 8, wherein this jacket 4 and the lid 8 can be embodied in one piece. Such an SMD component 28 can also be constructed without a jacket 4, in particular when molded metal particles or an electrically conductive plastic are/is used to form a connecting element 3 with a predefined volume area.

An SMD component 28 of the last-mentioned type according to FIG. 3d is shown by FIG. 4c in an electrical connection to a printed circuit board 2. Two pins 1 are arranged adjacent on this printed circuit board 2 with a spacing such that in each case such a pin 1 engages precisely with a contact face 11b of a connecting element 3.

FIGS. 4d and 4e show a further exemplary embodiment of a connecting element 3 according to aspects of the invention which is embodied as an SMD component 28. This cylindrical connecting element 3 can be constructed in accordance with the embodiments according to FIG. 3, FIGS. 4a to 4c, FIG. 6a, FIG. 7 or FIGS. 8a and 8b. This connecting element 3 can also be made of metal particle or metal mesh which is impregnated with elastic plastic, of course an electrically conductive plastic, preferably conductive rubber, which is embodied with the corresponding volume area is also suitable for this.

According to FIGS. 4d and 4e, such a connecting element 3 is inserted into an electrically conductive SMD adapter 14 which is soldered onto a printed circuit board 2 and which has a base surface, corresponding to the contact face 11a of the connecting element 3, and from which a plurality of arms engage around the adjacent jacket face of the connecting element 3 in a spider shape.

In a counter part or connecting element 3 which is manufactured from fine individual wires 5, copper or a copper alloy is preferably used as the base material, and depending on the application, for example (power demands, contact resistances), it is also possible to use other metals such as, for example, stainless steel etc. and they can also be silver-plated, gold-plated, tin-plated or nickel-plated.

In addition, such individual wires 5 are arranged as a bundle, as is explained below in conjunction with FIGS. 6a to 6d, or else arranged as brushes, wherein metallically coated non-conductors (for example plastic threads) can also be used. The arrangement composed of brushes or bundles or wire groupings which are held together by means of holding means, for example by means of a jacket 4 has an elastic volume such that one or more pins 1, embodied as pointed contact lances, of an electrical plug-in part can be plugged into the brushes or wire grouping in the longitudinal direction, that is to say in the z direction. In this context, the wires 5 which are preferably gold-plated, silver-plated or composed, for example, of stainless steel avoid the pin 1 or the contact lance 1 as a plug-in part and subsequently make contact with the latter over a large area. This also occurs if the conductive elements which are held by means of an elastic holding means form a dimensionally elastic connecting element 3.

The holding means 4, acting as an elastic or rigid sheath, of a wire grouping or the actual elastic property of the wires ensures a permanent electrical connection (over a large area and with multiple poles) to the connecting element.

The wires can be held together by an elastic jacket made of plastic, for example a silicone hose, as explained in conjunction with FIGS. 6a to 6d. However, given the alternative use of metal felt, metal wool, metal mesh or wire mesh or metal particles instead of wires as the conductive elements, the non-conductive material which is used for enveloping can also directly surround the metal felt, the metal wool, the metal mesh or the wire mesh and hold the latter in contact with adjacent metal particles, wires or metal felt particles or metal wool particles.

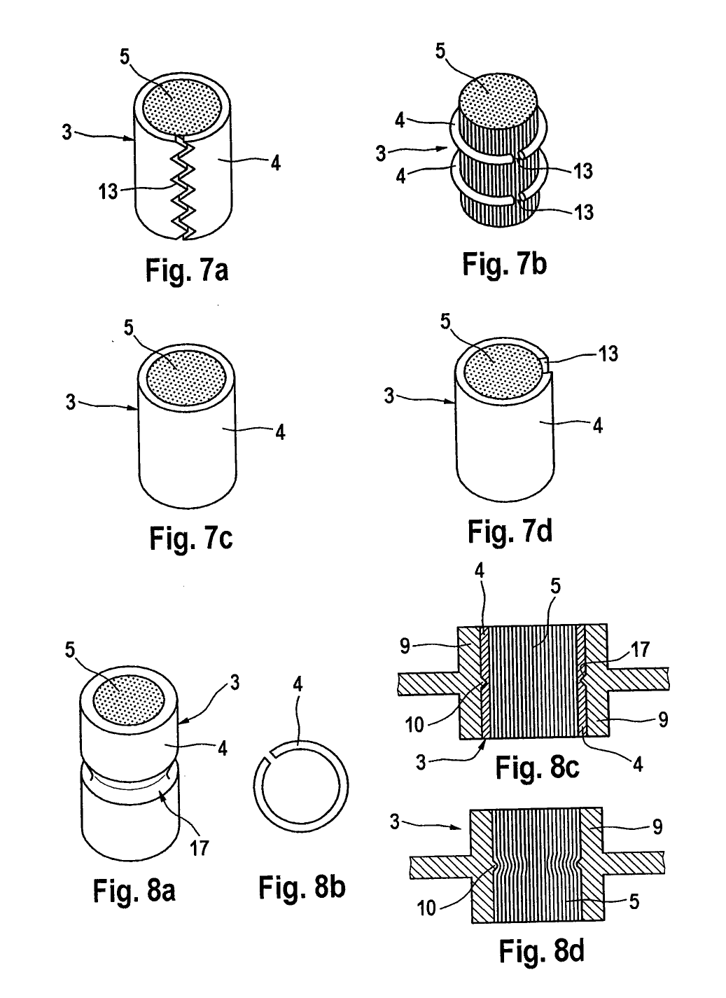

A holding means can also be composed of a crimped-on sleeve, a clamping ring or else a rigid sleeve, for example made of PBT, as illustrated in FIGS. 8a, 8b and FIGS. 7a to 7d. Finally, the holding means can also be a component of a housing, for example of a control unit or sensor, as is shown in FIGS. 8c and 8d.

The cross-sectional illustrations in FIGS. 6a to 6d show cross sections perpendicular to the z direction of exemplary connecting elements 3 according to aspects of the invention, which connecting elements 3 are composed of wires 5 as the electrically conductive elements and are held together to form wire groupings, wherein they differ from one another in the embodiment of the jacket 4 embodied as a holding means. Said jacket is in the case of a) a cylindrical jacket 4 which merely comprises one wire grouping, b) a four-conductor jacket 4 with four wire groupings, c) a three-conductor jacket 4 with three wire groupings and in the case of d) a two-conductor jacket 4 with two wire groupings. If a plurality of different contacts are therefore required, for example for the electricity supply and one or more signals, for example with two, three or four contacts, a counter part 3 or connecting section 3 which is provided with two, three or four fine-conductor wire groupings (as shown in FIG. 6 can preferably be used, said counter parts 3 or connecting sections 3 being constructed in accordance with a multi-conductor electric line in the illustrated cross section.

The circumference of the holding means 4 is usually embodied in the manner of a completely closed cylinder jacket, as shown in FIG. 7c. FIGS. 7a, 7b and 7d show exemplary embodiments of jackets 4 with an open sheath. In this context, in FIG. 7a the jacket is interrupted and therefore more elastic when penetrated by a pin 1 than the enclosed (solid) sheath in FIG. 7c. In FIG. 7b, the jacket 4 is composed of two or more clamping rings.

FIG. 8a shows a connecting element 3 with a crimped wire grouping brought about by means of a jacket 4 and composed of thin wires 5 by virtue of the fact that a circumferential bead 17 is inserted into the jacket 4. In FIG. 8c, a jacket 4 is held in a correspondingly shaped area of a housing 9. The housing 9 can expediently have an annular elevated portion 10 in the inner area, as a result of which the wires 5 and the jacket 4 are compressed and held in a partial region accompanied by the formation of a bead 17. FIG. 8b shows the possibility of a jacket 4 as a clamping ring as in FIG. 7b, wherein the clamping ring has an interruption which contributes to the elasticity when a pin 1 is plugged into the wire grouping composed of wires 5.

FIG. 8d shows how a connecting element 3 according to aspects of the invention without a jacket can be integrated into a housing. For this purpose, a wire bundle which is composed of wires 5 is pressed in accompanied by the formation of a tubular connecting element in, for example, the housing floor 9 of a plastic housing in such a way that a projection 10 which runs around in the connecting element connects this wire bundle composed of wires 5 fixedly to this housing floor 9 in the manner of a bead, with the result that said wire bundle does not drop out of the housing.

It is often necessary to prevent, in particular during the construction of vehicles, the penetration of fluids, moisture or gases into a plug-in connection. In an electric connector according to aspects of the invention which is composed of a connecting element and at least one pin this can be achieved in that, for example, the wire grouping composed of wires is wetted or filled with a sealing substance, for example two-component silicone gel, which is preferably fluid at the processing time, and these conductive elements, that is to say for example the wire grouping, take up the silicone due to the capillary effect and as a result seal the connecting element against other fluids (which occur later), in particular also against water and also against noxious gases at the later contact point and with respect to one another.

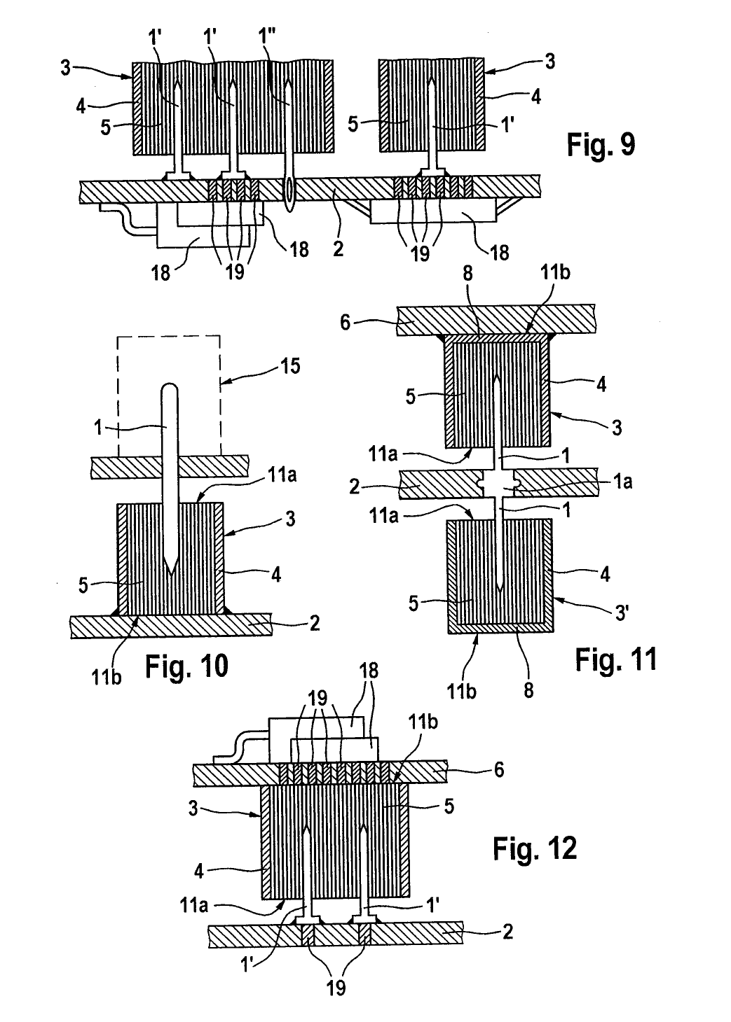

The electric connector according to aspects of the invention which is composed of a connecting element and at least one pin can be advantageously used in such a way that undesired thermal heating, such as occurs frequently in the case of tolerance-compensating electric connectors according to the prior art, is avoided owing to the relatively large effective contact face of the connecting element, as is explained below with reference to FIGS. 9 and 12.

According to FIG. 9, a printed circuit board 2 is equipped with electronic components 18, which can also be SMD components. At the locations at which a large amount of thermal heating occurs in the region of the components 18, vias 19 are provided which are filled with material with a high thermal conductivity. Provided in these regions are SMD pins 1′ and a press-in contact pin 1″, which are plugged into connecting elements 3 according to aspects of the invention which are constructed from conductive elements 5, preferably thin wires or stranded conductors with a corresponding jacket 4. The heat is initially fed through the vias 19 to the pins 1′ and 1″ and discharged from there to the connecting elements 3. In addition, electric contact can be made by a pin or by a plurality of such pins.

As is shown by FIG. 12, given a suitable design a connecting element 3 according to aspects of the invention can also be used as a cooling body for power components 18 by virtue of the fact that the connecting element 3 which is composed of thin metal wires, which may also be held together to form wire groupings or bundles, is both electrically and thermally connected to the power components 18 via the contact face 11b and metalized vias 19 of said connecting element 3. For this purpose, a number of vias 19 can also only be in thermal contact with the power components 18. The electrical connection is produced with two metallic lances 1′, which are embodied as SMD pins and are soldered to vias 19 of a printed circuit board 2. In the special case, it is also possible to dispense with an electrical connection to further components here.

Therefore, cooling can take place not only via pins 1 but also directly via the mass of the metal of the wire grouping, in particular via a direct contact with the component to be cooled (for example power semiconductor). The pins or lance contacts can be used here in particular both as a cooling element and as electrical contacts.

FIG. 10 shows an exemplary embodiment of a connection of a connecting element 3 to the plug pin 1 of a plug 15, which is, for example, injection-molded into a housing. The connecting element 3 which is composed, for example, of a stranded conductor 5 which is enclosed in a jacket 4, is electrically connected by its contact face 11b to a printed circuit board 2. The plug pin 1 of the plug 15 is plugged in via the other contact face 11a.

FIG. 11 shows two connecting elements 3 and 3′ with a double lance 1a, having two pins 1, for two connections lying opposite one another. For this purpose, the double lance 1a is arranged in a printed circuit board 2, with the result that a pin 1 protrudes perpendicularly on each side of the printed circuit board 2, and is plugged into a connecting element 3 or 3′, respectively, via a contact face 11a. The connecting elements 3 are each of identical construction with thin wires 5 which are held by a jacket 4, wherein the respective jacket 4 also comprises a lid 8 which covers the contact face 11b. The connecting element 3 is connected via the lid 8 to a printed circuit board 6.

In this exemplary embodiment according to FIG. 11, it is also possible for the connecting elements 3 and 3′ also to connect electrically to one another, depending on the application, a plurality of contacts, for example one soldered contact on a printed circuit board and one or more lance contacts of one or more components.

As an alternative to the lance contacts on a printed circuit board, the latter can also be a component of a housing and/or a component of a punched grille.

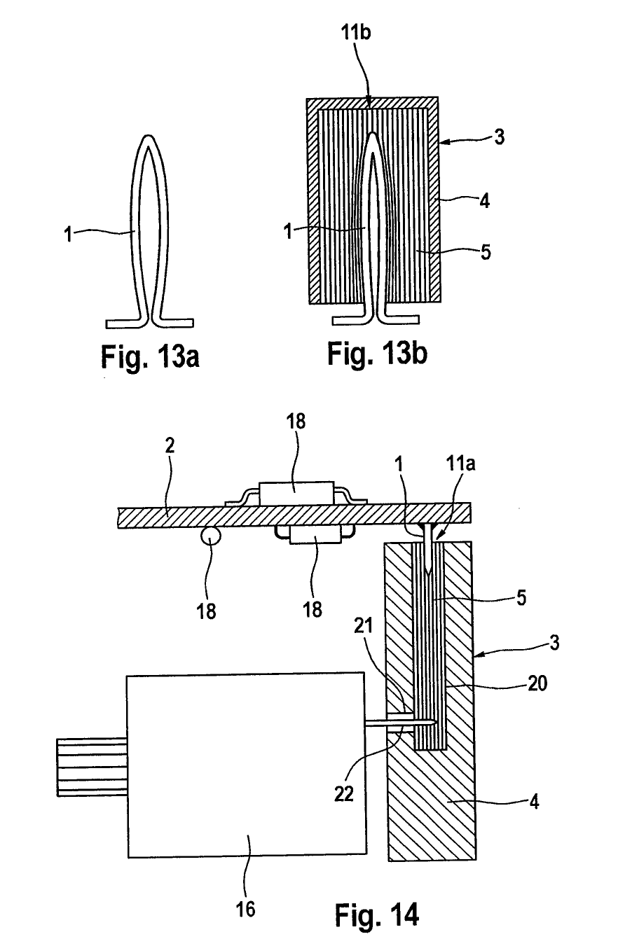

As is shown in FIG. 13a, in the case in which the mechanical prestress is not permanently sufficient to press the wire bundles composed of thin wires 5 against the pin 1 which is constructed as a lance contact, the lance contact 1 can also be embodied as a spring element, for example comparable to the eye of a needle or the gripping region of pincers. Therefore, as illustrated in FIG. 13b, when this lance contact 1 is inserted into, for example, the connecting element 3 which is made of thin wires 5 and enclosed with a jacket 4, these wires are pressed apart from one another to a greater extent than with customary pins, with the result that a higher pressing force against the wires 5 is achieved and at the same time these wires 5 are compressed more strongly.

It is particularly expedient in the connector according to aspects of the invention to use additional auxiliary lances which are composed, in particular, of plastic. The function thereof is to compress the wire grouping to a greater extent and therefore to ensure better pressing against the contact lance or lances.

In the case of electrical contacts, it is advantageous to coat the lances and wire grouping with gold or silver, in particular in the case of low currents and increased environmental conditions.

According to the cross-sectional illustration in FIG. 14, an electric component 16, for example an electric motor, a sensor or a coil with a printed circuit board 2, which can also be a circuit carrier or a punched grille, is able to electrically connect by means of a connecting element 3 according to aspects of the invention. This printed circuit board 2 has electronic components 18 on both sides and has, in the edge region, a pin 1 which is embodied as a connecting pin which is plugged into a contact face 11a of the connecting element 3 according to aspects of the invention. This connecting element 3 is either composed of thin wires 5, preferably of a stranded conductor, of metal particles which are embedded in plastic or of conductive rubber. In addition, the connecting element is enclosed in a cuboidal shape by means of a jacket 4 in such a way that, for example, the thin wires 5 or the conductive rubber run or runs in the longitudinal direction of the cube in a duct 20, with the result that the contact face 11a lies in a plane with an end side of the cuboidal jacket and adjacent to the printed circuit board face which bears the pin 1. An opening 21, through which connecting contacts 22 of the electric component 16 make contact with the stranded conductor 5 running, for example, in the duct 20, or the conductive rubber, is provided perpendicular to the longitudinal direction of the duct 20. It is particularly advantageous if the cuboidal jacket 4 is part of a housing wall of a plastic housing.

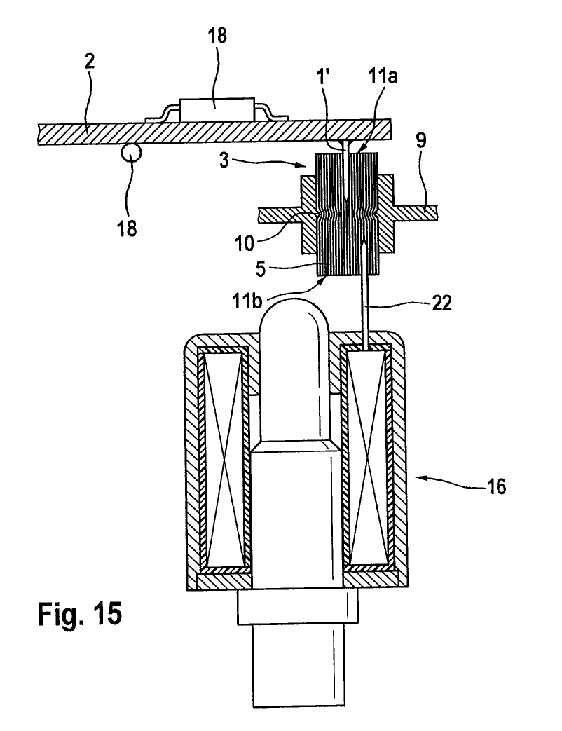

FIG. 15 shows a further application of a connecting element 3 which is integrated into a housing wall 9 of a housing and is constructed in accordance with FIG. 8d. A printed circuit board 2 which is equipped with electronic components 18 is located within the housing and is electrically connected to a contact face 11a of the connecting element 3 via, for example, an SMD pin 1′. The second contact face 11b, lying outside the housing, of the connecting element 3 is connected to a connecting contact 22 of a coil 16, in particular of a valve coil.

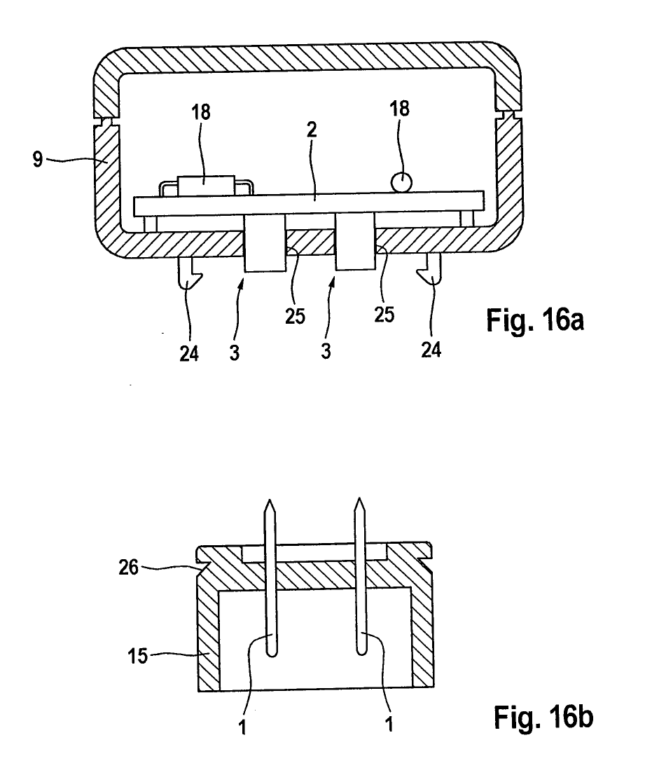

FIGS. 16a and 16b show a multi-component housing 9 with a printed circuit board 2 which is equipped with electronic components 18 and which through a housing wall by means of two connecting elements 3 according to aspects of the invention with contact pins 1 of a plug 15, which is connected to the housing 9 by means of latching means 24 and 26 by virtue of the fact that two latching hooks 24 on the housing 9 engage in a latching groove 26 running around the plug 15. The two connecting elements 3, which can be constructed in accordance with the described exemplary embodiments, are electrically connected to the rear of the printed circuit board 2, guided, for example, via a soldered connection and through housing openings 25, with the result that, when the plug 15 latches in, the plug pins 1 can penetrate the connecting elements 3.

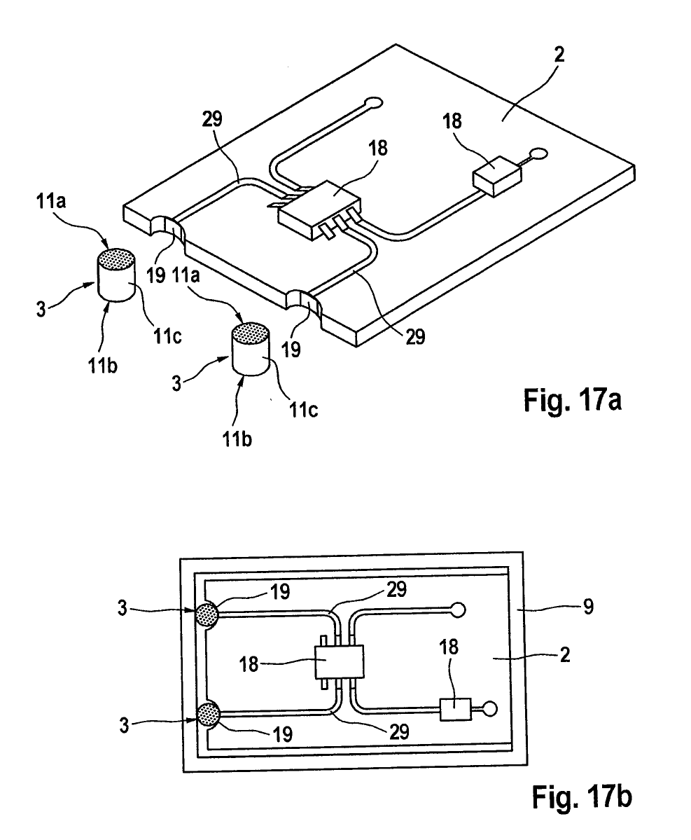

A further particularly advantageous use of connecting elements 3 according to aspects of the invention is shown in FIGS. 17 to 19. The connecting element 3 which is used has, in addition to the two end-side contact faces 11a and 11b, a further contact face 11c which is formed by the jacket face of the connecting element 3. Depending on the application case, the connecting element 3 can have a jacket which is electrically conductive or insulating. If the connecting element 3 makes contact with an electrically conductive face, the jacket face must also be electrically conductive, at least in the contact region. If, on the other hand, electrical contact is made via a pin, for example a penetration lance or an insulation piercing contact, a connecting element 3 with an insulating sheath can be used since the electrical connection is then produced by sticking it into the jacket.

According to FIG. 17a, a printed circuit board 2 is equipped with electronic components 18, with the result that contact is made with conductor tracks 29 which run on the printed circuit board 2. Two conductor tracks 29 are guided to an end side of the printed circuit board 2, where they end in a semicircular via 19 while forming an end-side contact face. The shape of the semicircle corresponds here to the dimensions of the connecting element 3, with the result that the latter can be inserted there in a positively locking fashion.

FIG. 17b shows the printed circuit board 2 from FIG. 17a in a plastic housing 9, wherein the connecting elements 3 are pressed into the vias 19 and the housing wall lying opposite, between the contact faces.

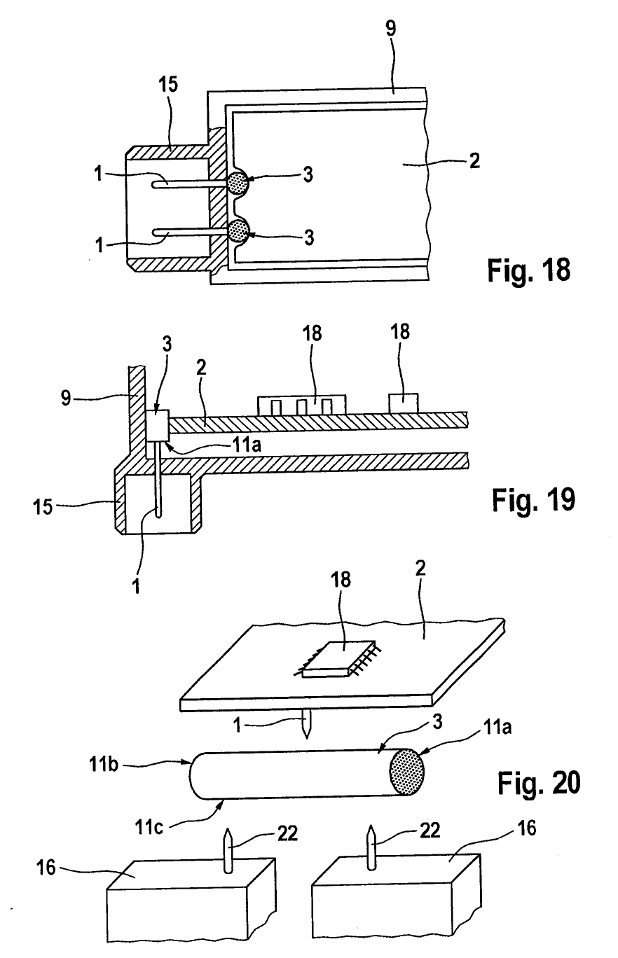

Contact can now be made to outside the housing 9 via the further contact face 11c or the end-side contact faces 11a or 11b. According to FIG. 18, contact is therefore made with the further contact face 11c of the connecting element 3 via plug pins 1 of a plug bushing 15, while according to FIG. 19 plug pins 1 of a plug bushing 15 make contact with the connecting elements 3 via the end-side contact face 11a thereof.

In addition, it is also possible to use only the further contact face 11c of a connecting element 3 according to aspects of the invention. Therefore, according to FIG. 20, a printed circuit board 2, which is equipped with electronic components 18, is electrically connected to two electric components 16, for example valve coils, via an elongate, cylindrical connecting element 3, wherein the two components 16 and the printed circuit board 2 are arranged lying opposite one another. The printed circuit board 2 is connected via a pin 1 to the connecting element 3, while the two components 16 are each placed in contact with the connecting element 3 via a connecting contact 22. The formation of contact with the printed circuit board 2 and with the two components 16 can be implemented, for example, by means of a plug-in lance as a pin 1 or by means of insulation piercing contacts.

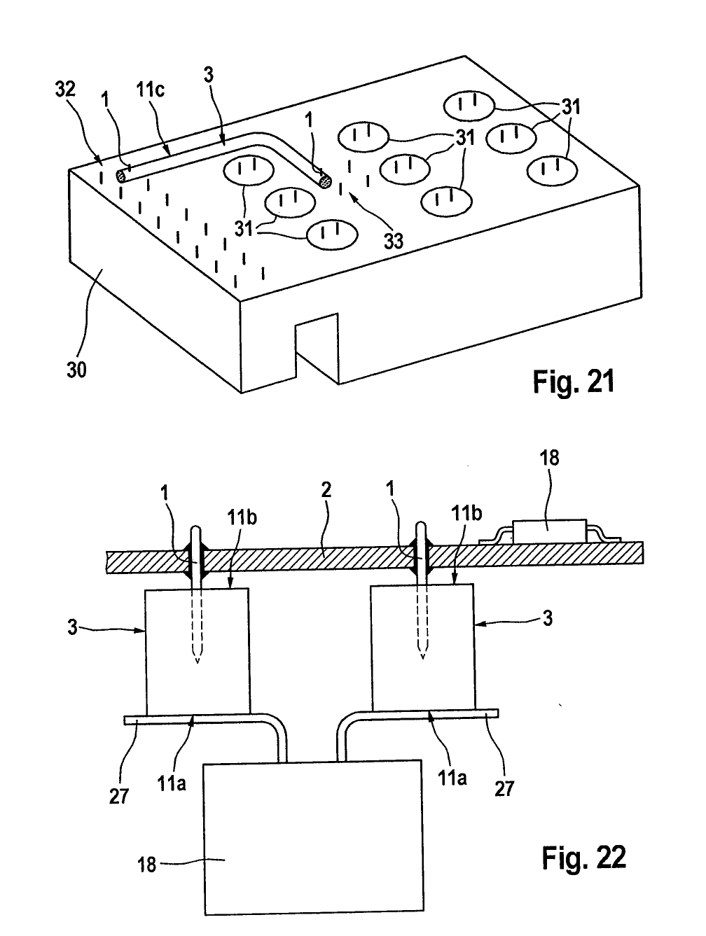

In a further exemplary embodiment according to FIG. 21, only the further contact face 11c of a connecting element 3 according to aspects of the invention is likewise placed in contact with pins 1. In this schematic FIG. 21, nine valve coils 31 are arranged in a valve block 33, wherein a multiple pin connector 32 with plug pins 1 is located in an edge region. In the central region of the valve block 31 there are further plug pins 1 which are a pump connection 33 for the hydraulics. The connecting element 3 is then guided at a right angle between a plug pin 1 of the multiple pin connector 32 and a pin 1 of the pump connection 33 in an arc about a valve coil 31, wherein the two pins 1 each form electrical contact via the further contact face 11c of the connecting element 3. The connecting element 3 can be constructed, for example, as a stranded conductor with an elastic sheath. Instead of the further contact face 11c, the end-side contact faces 11a and 11b can also be used for forming the contacts or for further contact-forming processes.

Finally, FIG. 22 also shows an advantageous use of connecting elements 3 according to aspects of the invention. Accordingly, a printed circuit board 2 which is equipped with electronic components 18 is connected electrically to a further electronic component 18 by the virtue of the fact that the connecting contacts 27 thereof are, for example, each soldered directly to a contact face 11a of the two connecting elements 3. Contact is formed with the two other end-side contact faces 11b of the two connecting elements 3 via pins 1 which are connected to the printed circuit board 2 and are embodied, for example, as press-in contact pins. It is also possible to solder the contact faces 11b directly to the printed circuit board 2.

The connecting elements according to aspects of the invention can be manufactured easily and in a lightweight fashion, in particular if thin wires are used for this which are held as a bundle or wire grouping, preferably stranded conductors. The wire grouping can preferably be manufactured by cutting off fine-wire line ends. In this context it is possible for the insulation of the lines, if insulation is present, to be used as an elastic sheath of the line grouping.

With such a mounting method it is advantageous when forming the electrical connection from the first contact face to hold the wire grouping of the connector in position from the other side.

Given a suitable design and connection of the connector, for example by soldering, crimping, clamping or molding with an elastic bonding agent, the connector can also be suitable for multiple plugging.

1.-41. (canceled)

42. An electric connector with a tolerance compensator composed of a plug-in part and a counter part,
wherein, when the plug-in part, comprising at least one electrically conductive pin, and the counter part are plugged together in a z-direction of a Cartesian coordinate system with vectors x, y and z, an electrical connection is produced,
wherein the counter part has an elastic volume and forms a predefined volume area, wherein the counter part is limited in the z-direction by, in each case, one end-side contact face,
wherein the at least one electrically conductive pin is oriented substantially in the counter part in the z-direction and substantially perpendicularly penetrates a contact face in order to form the electrical connection, and
wherein the predefined volume area which is formed by the counter part is dimensioned in such a way that the pin engages with the volume area within the scope of a permitted travel tolerance in the x and/or y directions when the plug-in part and the counter part are plugged together, in order to form a reliable electrical connection.

43. The electric connector as claimed in claim 42, wherein the volume area which is formed by the counter part has such a large extent in the z-direction that a permitted travel tolerance is also provided in the z-direction.

44. The electric connector as claimed in claim 42, wherein the counter part forms a volume area with a plurality of electrically conductive elements.

45. The electric connector as claimed in claim 44, wherein the electrically conductive elements of the counter part are embodied as thin, electrically conductive elements which extend essentially in the z-direction.

46. The electric connector as claimed in claim 44, wherein wire, metal felt, metal wool, metal mesh or metalized plastic fabric is used to form the electrically conductive elements of the counter part.

47. The electric connector as claimed in claim 42, wherein the counter part is of dimensionally elastic design.

48. The electric connector as claimed in claim 45, wherein the conductive elements are held together by a holding means.

49. The electric connector as claimed in claim 48, wherein the electrically conductive elements of the counter part are combined, using the holding means as at least one bundle, a bundle of electrically conductive wires, at least one stranded conductor or one bundled piece of metal felt, metal wool, metal mesh or metalized plastic fabric.

50. The electric connector as claimed in claim 48, wherein the holding means is a jacket, a dimensionally elastic jacket, a ring, a braided element, a twisted element or an adhesive material.

51. The electric connector as claimed in claim 48, wherein the holding means surrounds the volume area, formed by the counter part, with the conductive elements at least partially in an annular shape or cylindrical shape, wherein the holding means has an interruption which acts elastically when the pin is inserted into the volume area.

52. The electric connector as claimed in claim 49, wherein the holding means comprises a jacket which is constructed with one conductor, two, three or four conductors in order to accommodate one, two, three or four bundles of conductive elements, or has more than four conductors in order to accommodate more than four bundles of conductive elements.

53. The electric conductor as claimed in claim 52, wherein the jacket is held by a housing which surrounds the jacket in an annular shape and preferably has an annular elevated portion which compresses the jacket.

54. The electric connector as claimed in claim 48, wherein the holding means is embodied as an integrated part of a housing or a housing wall of a plastic housing.

55. The electric connector as claimed in claim 48, wherein the holding means encloses the electrically conductive elements in a jacket shape and surrounds the edge area of a contact face in the manner of a frame.

56. The electric connector as claimed in claim 48, wherein the contact face of the counter part is of solderable design.

57. The electric connector as claimed in claim 48, wherein a contact face of the counter part is provided with an electrically conductive lid.

58. The electric connector as claimed in claim 57, wherein a metallic jacket as holding means and the electrically conductive lid are embodied in one piece.

59. The electric connector as claimed in claim 44, wherein thin wires are arranged as electrically conductive elements substantially parallel to the z-direction or stranded in the volume area formed by the counter part.

60. The electric connector as claimed in claim 44, wherein the conductive elements are wetted with an adhesively acting bonding agent.

61. The electric connector as claimed in claim 44, wherein the conductive elements are crosslinked with a plastic with an elastic volume.

62. The electric connector as claimed in claim 44, wherein the conductive elements are embodied as electrically conductive metal particles or metalized particles, which are embedded in a plastic with an elastic volume.

63. The electric connector as claimed in claim 42, wherein the counter part for embodying the volume area is formed from either an electrically conductive plastic or a conductive polymer.

64. The electric connector as claimed in claim 63, wherein the counter part is composed of conductive rubber.

65. The electric connector as claimed in claim 63, wherein the counter part is of cylindrical design, wherein the longitudinal axis thereof is oriented approximately in the z-direction.

66. The electric connector as claimed in claim 42, wherein a circumferential face of the counter part forms, in addition to the end-side contact face, a further contact face in the z-direction.

67. The electric connector as claimed in claim 66, wherein the further contact face of the counter part is formed by an electrically conductive jacket.

68. The electric connector as claimed in claim 42, wherein, in order to embody the counter part as an SMD component, an SMD adapter which is embodied in a spider shape is provided, which SMD adapter encloses an end-side contact face and an adjoining circumferential face of the counter part.

69. The electric connector as claimed in claim 42, wherein the pin and/or the counter part are/is electrically connected to a printed circuit board.

70. The electric connector as claimed in claim 42, wherein two end-side contact faces of the counter part are each connected to a printed circuit board or to an electric component via a pin.

71. The electric connector as claimed in claim 42, wherein a first and a second counter part are connected to one another via a double pin, wherein the double pin is arranged in a printed circuit board.

72. The electric connector as claimed in claim 42, wherein an end of the pin which lies opposite the counter part forms a plug pin.

73. The electric connector as claimed in claim 42, wherein the counter part is guided in an arcuate shape from one contact terminal to a further contact terminal, wherein at least one contact terminal makes contact, by means of a pin, with the counter part via its further contact face.

74. The use of the connector as claimed in claim 42 for cooling electronic components.

75. The use as claimed in claim 74, wherein the pin is arranged directly so as to conduct away heat at a location which is to be cooled on a printed circuit board, and the pin serves additionally also to conduct away heat to the electrical connection to the counter part.

76. The use as claimed in claim 74, wherein the counter part is arranged directly so as to conduct away heat at a location which is to be cooled on a printed circuit board, and at least one pin forms an electrical connection.

77. The use of the connector as claimed in claim 42 for connecting a sensor or a pressure sensor to an electronic unit.

78. The use as claimed in claim 77, wherein contact is made with the sensor when a hydraulic unit ECU is connected to an electronic control device HCU, wherein the electric connector compensates fabrication tolerances with respect to a position of the electrical connection.

79. The use of the connector as claimed in claim 42 for electrically connecting a plurality of electric components to a common potential and to drive electronics.

80. The use of the connector as claimed in claim 79, wherein the electric components are valve coils of an ABS control unit.

81. The use of the connector as claimed in claim 42 for electrically connecting a printed circuit board, via a further contact face of the counter part, to a pin which forms a plug pin.

82. The use as claimed in claim 81, wherein, in order to place the further contact face of the counter part in contact with a printed circuit board, the counter part is introduced into a via in the printed circuit board.

83. The use as claimed in claim 82, wherein the via is arranged in a semicircular shape on an end side of the printed circuit board, and the counter part is clamped in between a housing wall and the semicircular shaped via.
